(19) United States
(12) Patent Application Publication
(10) Pub. No.: US 2023/0355356 A1
(43) Pub. Date: Nov. 9, 2023

(54) PONTIC WITH ARCHWIRE CONNECTION

(71) Applicant: LightForce Orthodontics, Inc., Burlington, MA (US)

(72) Inventors: Oisin Duggan, Somerville, MA (US); Kelsey A. Fafara, Watertown, MA (US); Christina Bonebreak Jackson, Lexington, MA (US); Dylan Winchell, Somerville, MA (US)

(73) Assignee: LightForce Orthodontics, Inc., Burlington, MA (US)

(21) Appl. No.: 18/312,115

(22) Filed: May 4, 2023

Related U.S. Application Data
(60) Provisional application No. 63/338,556, filed on May 5, 2022.

(51) Int. Cl. A61C 7/20; A61C 7/00

(52) U.S. Cl. CPC A61C 7/20; A61C 7/002

(57) ABSTRACT

The techniques described herein relate to exemplary pontics with archwire connections. An example appliance for spanning a mesiodistal width of a missing tooth includes a pontic portion at least partially coated with a material that is softer than tooth enamel, an archwire connection portion attached to a first side of the pontic portion, and at least one stabilizer affixed to a second side of the pontic portion, the second side opposite the first side.

### RELATED APPLICATION

This patent claims priority under 35 U.S.C. § 119(e) to U.S. Provisional Application No. 63/338,556, titled “PONTIC WITH ARCHWIRE CONNECTION,” filed on May 5, 2022, which is hereby incorporated by reference herein in its entirety.

### FIELD

The techniques described herein relate generally to dental appliances and, more particularly, to exemplary pontics with archwire connections.

### BACKGROUND

Orthodontic patients sometimes have one or more missing teeth creating a gap. A tooth may be missing because it was extracted, or because a deciduous tooth was lost and a permanent tooth has yet to erupt. In some cases, an orthodontic treatment plan can include movement of teeth adjacent to the gap to close the gap. In other cases, the orthodontic treatment plan can maintain the gap during treatment. A pontic, which is a temporary prosthetic replacement of the missing tooth, can be used as an aesthetic accessory to fill the gap during treatment.

A pontic can be formed from an acrylic material and a stock orthodontic bracket can be bonded to the pontic. Then, the bracket can be ligated to an archwire. Failure of the bond between the pontic and bracket can be harmful since the pontic can become a loose body that can be swallowed. Furthermore, pontics can be laborious to manufacture, typically requiring a medical professional, such as a doctor, to build one up or modify a crown or denture to fill the gap.

### SUMMARY OF THE DISCLOSURE

In accordance with the disclosed subject matter, exemplary pontics with archwire connections are provided.

Some embodiments relate to an exemplary appliance for spanning a mesiodistal width of a missing tooth. The appliance comprises a pontic portion at least partially coated with a material that is softer than tooth enamel; an archwire connection portion attached to a first side of the pontic portion; and at least one stabilizer affixed to a second side of the pontic portion, the second side opposite the first side.

Some embodiments relate to a method for manufacturing an appliance for spanning a mesiodistal width of a missing tooth. The method comprises measuring dentition data associated with a patient; generating a computer model of teeth of the patient, the computer model to maintain at least one gap for at least one pontic; and constructing, using an additive manufacturing process, the appliance based on at least one of the dentition data or the computer model, the appliance comprising: a pontic portion at least partially coated with a material that is softer than tooth enamel; an archwire connection portion attached to a first side of the pontic portion; and at least one stabilizer affixed to a second side of the pontic portion, the second side opposite the first side.

Some embodiments relate to an apparatus comprising a memory storing instructions, and a processor configured to execute the instructions to perform the aforementioned method.

Some embodiments relate to at least one non-transitory computer-readable storage medium comprising instructions that, when executed, cause a processor to perform the aforementioned method.

The foregoing summary is not intended to be limiting. Moreover, various aspects of the present disclosure may be implemented alone or in combination with other aspects.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 depicts a plurality of example appliances including pontic portions and archwire connection portions, according to some embodiments.

FIG. 2 depicts a plurality of example appliances coupled to an archwire, according to some embodiments.

FIG. 3A is a front view of an example stabilizer coupled to a surface of an example appliance that is coupled to an archwire, according to some embodiments.

FIG. 3B is a top view of the stabilizer, appliance, and archwire of FIG. 3A, according to some embodiments.

FIG. 4A is a rear view of a plurality of example stabilizers coupled to an example appliance, according to some embodiments.

FIG. 4B is a top view of the plurality of stabilizers and the appliance of FIG. 4A, according to some embodiments.

FIG. 4C illustrates a sectional view of an example appliance including a pontic portion, an archwire connection portion, and stabilizers, according to some embodiments.

FIG. 5A is a top view of an occlusal view of an upper archform associated with a treatment plan for a patient, according to some embodiments.

FIG. 5B is a side view of the upper archform of FIG. 5A, according to some embodiments.

FIG. 6 shows an example appliance manufacturing system including an additive manufacturing system to construct appliances, according to some embodiments.

FIG. 7 is a flowchart representative of example machine-readable instructions that may be executed by processor circuitry to implement the electronic device of FIG. 6 to construct example appliances, according to some embodiments.

FIG. 8 is an electronic platform structured to execute the machine-readable instructions of FIG. 7 to implement the electronic device of FIG. 6, according to some embodiments.

### DETAILED DESCRIPTION

The present application relates to pontics. The present application provides example implementations of a pontic with an archwire connection. The present application also provides example techniques for designing and/or manufacturing the same.

Dental treatment plans, such as orthodontic treatment plans, may include performing sequence(s) of operations with dental hardware to achieve a desired outcome for a patient. Non-limiting examples of desired outcomes include an aesthetic outcome and a dental health outcome. For example, an aesthetic outcome may be the straightening of one or more teeth, which is a typical outcome of orthodontic treatment plans. An exemplary dental health outcome may be the filling of a gap between teeth to ensure teeth proximate the gap are not adversely affected, such as by becoming weakened and/or becoming loose.

Some conventional appliances may be formed by using multiple manufacturing processes to achieve a patient's prescription. For example, a pontic portion may be constructed using a first manufacturing process and an archwire connection portion may be constructed using a second manufacturing process. In some such examples, the pontic portion may be formed separately from the archwire connection portion, followed by bonding of the archwire connection portion to the pontic portion.

The inventors have recognized that one challenge of using conventional appliances is that they may pose potential hazards to a patient. For example, an appliance with multiple portions that are separately manufactured may present a heightened risk for the portions to separate. In some such examples, the pontic portion may become debonded from the archwire connection portion, which can cause the pontic portion to become a swallowing and/or choking hazard for the patient.

The inventors have recognized that another challenge of using conventional appliances is that they can rotate, spin, and/or otherwise move about and/or around the archwire connection portion. For example, conventional pontics are not implants and thereby are not attached to the gums or adjacent teeth. Due to the lack of attachment(s), conventional pontics lack control of labiopalatal rotation of the pontic portion around the archwire connection portion. In some instances, the rotation of the pontic portion may introduce stress to the bond between the pontic and archwire connection portions and, thus, may cause the bond to break and introduce the loosened pontic as a swallowing and/or choking hazard to the patient.

The inventors have developed example appliances, such as pontics with archwire connections, and example techniques for designing and/or manufacturing the same to overcome the aforementioned challenges. In one aspect, the technology disclosed herein provides an appliance, which may be implemented by a pontic with an archwire connection, for spanning a mesiodistal width of a missing tooth. In some embodiments, the appliance can include a pontic portion and an archwire connection portion protruding from a first surface of the pontic portion. In some embodiments, the first surface can be a buccal surface or a lingual surface of the pontic. In some embodiments, the archwire connection portion can be permanently affixed to the pontic portion.

In some embodiments, additive manufacturing (e.g., three-dimensional (3D) printing) can be used to overcome the challenge of conventional appliances having portions that debond from each other. For example, additive manufacturing can form the exemplary appliances, including the pontic portion and the archwire connection portion, as a single body (e.g., a uniform body, a single structure, etc.) to achieve a patient's prescription. For example, an additive manufacturing system can form the appliance using unibody construction. In some such examples, the additive manufacturing system can form the pontic and archwire connection portions as a single structure using a single manufacturing process to achieve a patient's prescription.

In some embodiments, 3D printing an exemplary pontic as disclosed herein is beneficial because the exemplary pontic can be manufactured as a custom pontic based on the patient's teeth. For example, a custom pontic can be manufactured based on (e.g., as a mirror image) of the tooth on the opposite side of the patient's mouth to achieve an aesthetic outcome (e.g., the custom pontic has an improved appearance when compared to a non-custom pontic). In some embodiments, 3D printing is beneficial because a stock pontic can be printed from a library.

Beneficially, fewer manufacturing processes are needed to form the appliances disclosed herein compared to conventional appliances. For example, to form the appliances disclosed herein, a pontic portion may not need to be formed separately from an archwire connection portion, followed by bonding of the archwire connection portion to the pontic portion, as may be needed for conventional appliances. Alternatively, the pontic portion and the archwire connection portion may be manufactured separately, and bonded prior to installation of the appliance using exemplary technology disclosed herein to reduce the risk of debonding. Beneficially, a custom, unibody appliance can apply force with more precision, resulting in more predictable treatment outcomes. Further, a custom, unibody appliance can present a lesser risk for the pontic portion becoming debonded from the archwire connection portion, where a debonded pontic portion represents a swallowing and/or choking hazard.

In some embodiments, appliances overcome the challenge of conventional appliances lacking control of labiopalatal rotation of the pontic portion around the archwire connection portion. For example, disclosed appliances can include means for controlling labiopalatal rotation of the pontic portion around the archwire connection portion. In some such examples, the means for controlling labiopalatal rotation can be implemented by at least one stabilizer affixed to a second surface of the pontic portion. For example, the second surface can be a lingual surface of the pontic portion when the first surface is a buccal surface of the pontic portion. In some embodiments, the second surface can be a buccal surface when the first surface of the pontic portion is a lingual surface.

In some embodiments, a mesial-distal slot of the archwire connection portion can include means for controlling labiopalatal rotation of the pontic portion around the archwire. For example, the means for controlling labiopalatal rotation can be implemented by a coarse surface (e.g., a rough surface, a roughened surface) or a surface shaped to inhibit rotation. For example, a surface shaped to inhibit rotation can be implemented by a friction surface that inhibits rotation but permits the archwire to slide through a connector of the archwire connection portions affixed to the pontic portion. In some embodiments, the archwire connection portion can be implemented by a bracket or a tube. For example, the bracket can be a self-ligating bracket that locks onto the archwire. In some embodiments, the bracket can have one or more protuberances, such as bracket tie wing, that enable ligation of the bracket to adjacent brackets to control labiopalatal rotation.

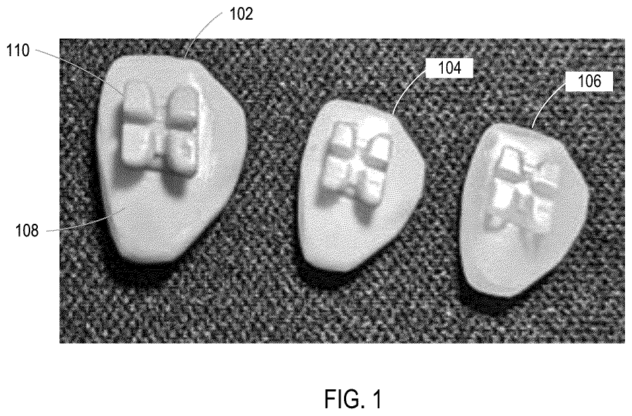

Turning to the figures, the illustrated example of FIG. 1 depicts a plurality of example appliances 102, 104, 106 respectively including a pontic portion 108 and an archwire connection portion 110. In some embodiments, one(s) of the appliances 102, 104, 106 may be inserted, installed, etc., in a mouth of a patient (e.g., a human patient, a child, an adult, etc.) to achieve a desired outcome, such as an aesthetic and/or dental health outcome. For example, one(s) of the appliances 102, 104, 106 may be inserted in gap(s) of a child patient's mouth to facilitate the performance of an orthodontic treatment plan. In some embodiments, one(s) of the appliances 102, 104, 106 can be a passive accessory such as to not be clinically and/or functionally active throughout orthodontic treatment.

In the illustrated example, the pontic portion 108 is a pontic, which is a synthetic tooth (e.g., a false tooth, a replacement tooth, etc.) that may be used to replace a missing tooth. In some embodiments, the pontic portion 108 can be manufactured from a ceramic material (e.g., alumina, zirconia, etc.). In some embodiments, the pontic portion 108 can be at least partially coated with a material that is softer than or equivalent to tooth enamel (e.g., a pontic paint) to reduce and/or prevent damage to neighboring teeth (e.g., to reduce and/or prevent enamel damage). In some embodiments, the material can contain acrylate. For example, the weight content of the acrylate can be between 40 percentage by weight (wt %) and 70 wt %. For example, the material can be a pontic paint that contains acrylate with a weight content between 40 wt % and 70 wt %. Beneficially, in some embodiments, the material can be selected to customize the pontic color to adjacent teeth (e.g., to shade match the pontic portion 108 to adjacent teeth), protect teeth from unnecessary wear, and/or protect soft tissue from damage. In some embodiments, the pontic portion 108 can be manufactured from an acrylic or polymer material, or a material used for crowns or veneers.

In the illustrated example, the archwire connection portion 110 is a bracket (e.g., a bracket portion of the appliances 102, 104, 106). For example, the archwire connection portion 110 can be constructed, formed, etc., in the shape of an orthodontic bracket. In some embodiments, the bracket is a self-ligating bracket that locks onto an archwire configured to be coupled to the bracket. In some embodiments, the bracket can have one or more protuberances, such as bracket tie wing, that enable ligation of the bracket to adjacent brackets to control labiopalatal rotation.

Beneficially, in some embodiments, the archwire connection portion 110 can be manufactured to match the shape (e.g., the approximate shape, the general shape, etc.), color, and/or finish of archwire connection portions affixed to adjacent teeth. In some embodiments, other orthodontic attachments (e.g., orthodontic appliances) may be affixed to the pontic portion 108 instead of or in addition to the archwire connection portion 110. Non-limiting examples of other orthodontic attachments include a button, a hook, and a tube.

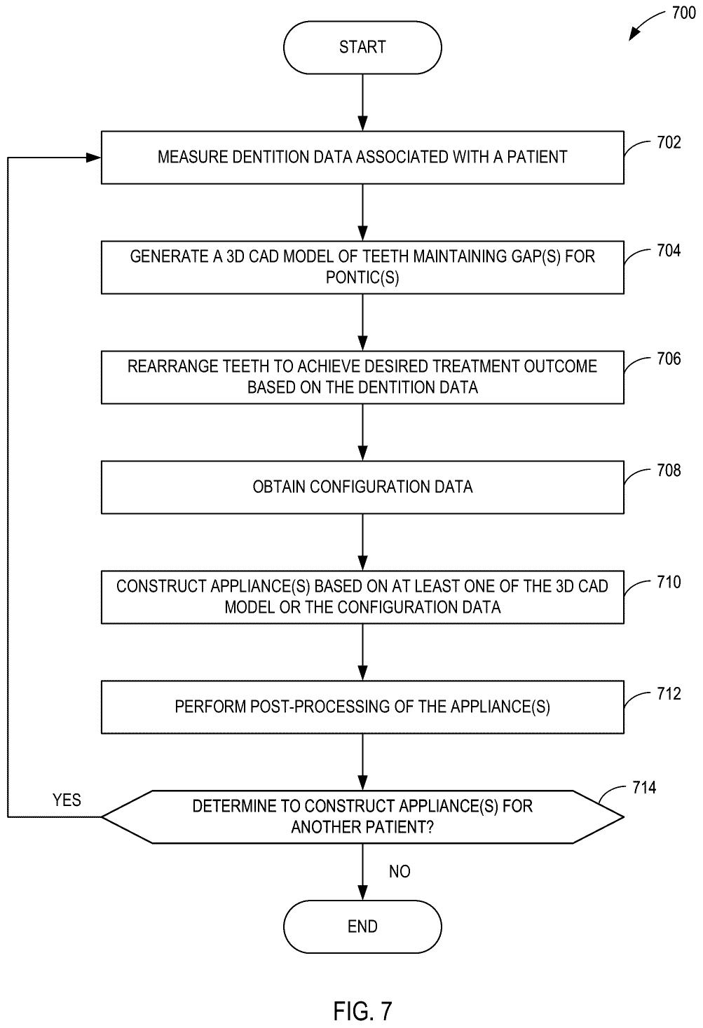

In some embodiments, the archwire connection portion 110 is coupled to the pontic portion 108. For example, the archwire connection portion 110 can be coupled to a surface of the pontic portion 108 via a bonding process using one or more adhesives, cements, gels, and/or other chemical bonding agents. In some embodiments, the archwire connection portion 110 is part of the appliance 102, 104, 106 such that the archwire connection portion 110 and the pontic portion 108 form a unibody appliance (e.g., a custom, unibody appliance). For example, the pontic portion 108, the archwire connection portion 110, and/or, more generally, the appliances 102, 104, 106, can be formed using unibody construction by using an additive manufacturing process as disclosed in U.S. Pat. No. 10,241,499 assigned to LightForce Orthodontics, Inc., and the entire contents of which are incorporated herein by reference. An exemplary process for designing and/or manufacturing the pontic portion 108, the archwire connection portion 110, and/or, more generally, the appliances 102, 104, 106, is described below in connection with FIG. 7.

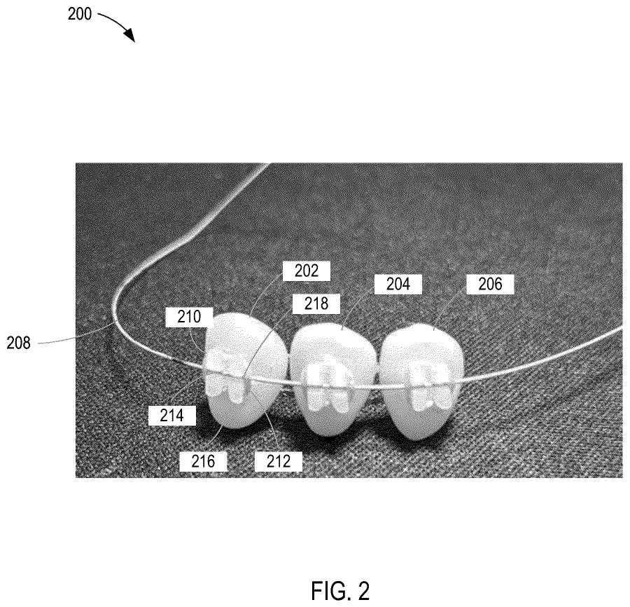

FIG. 2 depicts an example assembly 200, such as a dental assembly, including a plurality of example appliances 202, 204, 206 coupled to an archwire 208. In the illustrated example, archwire connection portions 210 of the appliances 202, 204, 206 are coupled to the archwire 208. For example, the appliances 202, 204, 206 are coupled to the archwire 208 by fastening the archwire 208 to the archwire connection portions 210 using resilient tie ligatures 212. In some embodiments, the resilient tie ligatures 212 are ligating ties, which are used to retain the archwire 208 in slots 214 of the archwire connection portions 210 to achieve a dental outcome, such as orthodontic tooth movement. In some embodiments, the resilient tie ligatures 212 are elastic ligatures while, in other embodiments, they may be metal ligatures or self-ligation ligatures.

In some embodiments, a mesial-distal slot 218 of the archwire connection portions 210 can include means for controlling labiopalatal rotation of a pontic portion 216 around the archwire 208. For example, the means for controlling labiopalatal rotation can be implemented by a coarse surface (e.g., a rough surface, a roughened surface) or a surface shaped to inhibit rotation. For example, the mesial-distal slot 218 can have a surface shaped to inhibit rotation the surface can be implemented by a friction surface that inhibits rotation but permits the archwire 208 to slide through the archwire connection portions 210 affixed to the pontic portion 216.

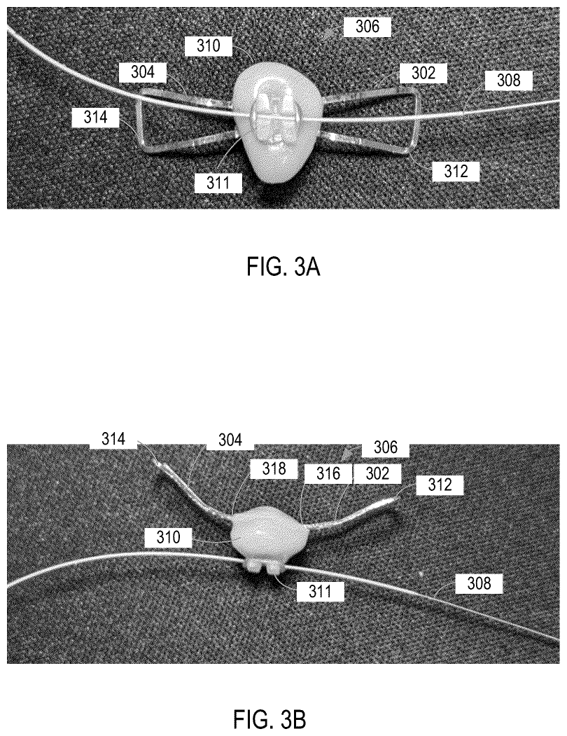

FIGS. 3A and 3B depict a front view and a top view, respectively, of example stabilizers 302, 304 coupled to a surface of an example appliance 306 that is coupled to an archwire 308. In the illustrated examples of FIGS. 3A-3B, the stabilizers 302, 304 are configured to engage adjacent teeth to maintain the position and orientation of a pontic portion 310 of the appliance 306 when the appliance 306 is attached to the archwire 308.

In some embodiments, the stabilizers 302, 304 implement means for controlling labiopalatal rotation of the pontic portion 310 around an archwire connection portion 311. In the illustrated example, the means for controlling labiopalatal rotation can be implemented by at least one of the stabilizers 302, 304 affixed to a lingual surface of the pontic portion 310. In some embodiments, the means for controlling labiopalatal rotation can be implemented by at least one of the stabilizers 302, 304 affixed to a buccal surface of the pontic portion 310.

In the illustrated examples, the stabilizers 302, 304 are respectively formed as wings having a protruding shape, such as a dovetail shape. Additionally or alternatively, the stabilizers 302, 304 of the illustrated examples have a butterfly shape, such as each of the stabilizers 302, 304 having a shape akin to a butterfly wing or any other wing, such as a dragonfly or moth wing.

In some embodiments, the stabilizers 302, 304 can be formed from one or more metals. Non-limiting examples of metal include nickel titanium alloy, stainless steel, and titanium. In some embodiments, the stabilizers 302, 304 can be formed from one or more polymers. In some embodiments, shapes of the stabilizers 302, 304 can be customized to the shapes of adjacent teeth to facilitate placement, bonding, and/or control labiopalatal rotation.

In the illustrated examples of FIGS. 3A-3B, the stabilizers 302, 304 have a unibody construction. For example, the stabilizers 302, 304 can be stamp formed or constructed from a bending of a single body. Non-limiting examples of a body may be a bar, a cord, a rail, a strip, and a wire. Alternatively, one or both stabilizers 302, 304 may have a multibody construction, such as being constructed from multiple bodies that are coupled together. For example, multiple metal bodies may be fused, melted, and/or otherwise joined together.

In the illustrated examples of FIGS. 3A-3B, the stabilizers 302, 304 are embedded in the pontic portion 310 of the appliance 306. For example, the stabilizers 302, 304 are affixed to a first side, such as a back surface (e.g., a rear surface) of the pontic portion 310 of the appliance 306. Alternatively, one or both stabilizers 302, 304 may be affixed to a second side, opposite the first side, such as a front surface of the appliance 306. For example, the stabilizers 302, 304 may be affixed to a front surface of the appliance 306 (not shown). In some embodiments, a first stabilizer 302 may be affixed to a front surface of the appliance 306 (not shown) and a second stabilizer 304 may be affixed to a back surface of the appliance 306 (shown).

In some embodiments, the stabilizers 302, 304 can be embedded in the pontic portion 310 during manufacturing of the pontic portion 310. In the illustrated examples of FIGS. 3A-3B, the stabilizers 302, 304 are embedded in the pontic portion 310 by being at least partially integrated into a body of the pontic portion 310 of the appliance 306. For example, the stabilizers 302, 304 have first ends 312, 314 and second ends 316, 318. The first ends 312, 314 extend away from the pontic portion 310. The second ends 316, 318 are at least partially inserted in an interior of the pontic portion 310. For example, the second ends 316, 318 may be placed into an appliance mold during manufacturing of the appliance 306, such that when the appliance mold is filled with material(s) as disclosed herein, the second ends 316, 318 may be embedded in the interior of the pontic portion 310 when the material(s) cure and/or harden. Alternatively, the stabilizers 302, 304 may be bonded to a surface of the pontic portion 310 after the manufacturing of the pontic portion 310.

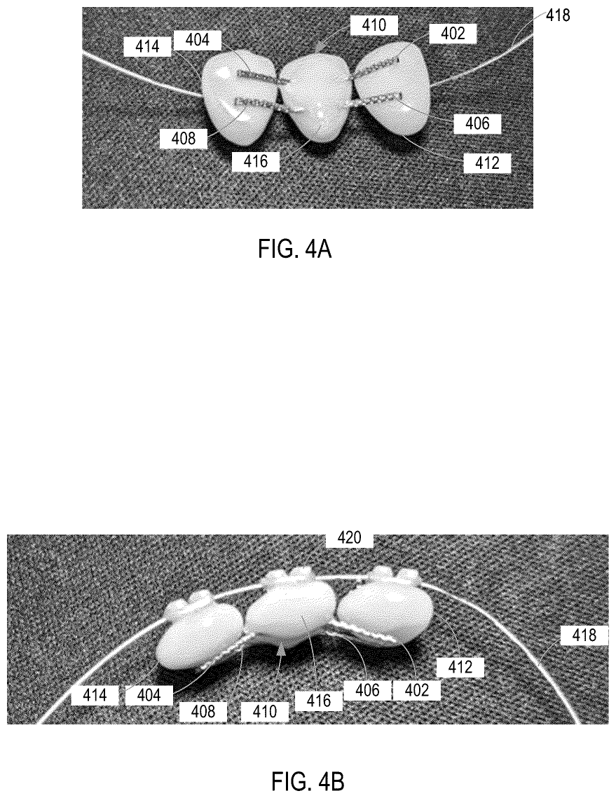

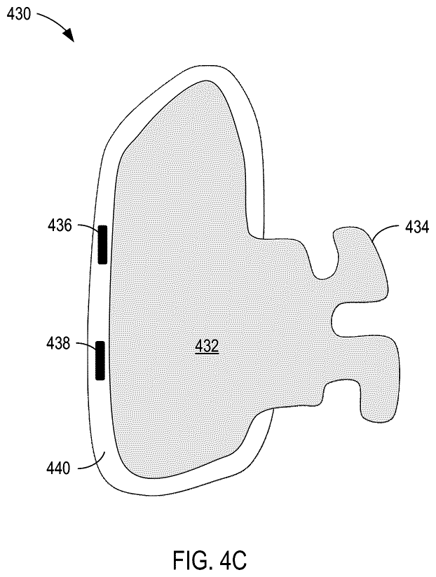

FIGS. 4A and 4B depict a rear view and a top view, respectively, of a plurality of example stabilizers 402, 404, 406, 408 coupled to an example appliance 410. The appliance 410 of this example may correspond to one(s) of the appliances 102, 104, 106 of FIG. 1, one(s) of the appliances 202, 204, 206 of FIG. 2, and/or the appliance 306 of FIGS. 3A-3B. The stabilizers 402, 404, 406, 408 of these examples are affixed to a back surface of the appliance 410. Alternatively, one(s) of the stabilizers 402, 404, 406, 408 may be affixed to a front surface of the appliance 410, opposite the back surface.

The stabilizers 402, 404, 406, 408 of these examples are configured to engage adjacent teeth 412, 414 to maintain the position and orientation of a pontic portion 416 when the appliance 410 is attached to an archwire 418. For example, the stabilizers 402, 404, 406, 408 can engage one or both of the adjacent teeth 412, 414 by being bonded to the adjacent teeth 412, 414 using an adhesive or cement. Additionally or alternatively, the stabilizers 402, 404, 406, 408 may engage one or both of the adjacent teeth 412, 414 using a pressure fit such that no adhesives or cement is utilized. In some embodiments, first ones of the stabilizers 402, 404, 406, 408 can engage one of the adjacent teeth 412, 414 using bonding and second ones of the stabilizers 402, 404, 406, 408 can engage a different one of the adjacent teeth 412, 414 using a pressure fit. The stabilizers 402, 404, 406, 408 of these examples are formed as bars extending from the pontic portion 416 but in other embodiments may be formed as any other shape and/or structure to maintain the position and orientation of the pontic portion 416 when the appliance 410 is attached to the archwire 418 via an archwire connection portion 420.

The stabilizers 402, 404, 406, 408 of these examples have a coarse surface (e.g., a crimped surface, a rough surface, a roughened surface, a textured surface) such as a surface shaped to inhibit movement of the stabilizers 402, 404, 406, 408. For example, a surface shaped to inhibit movement can be implemented by a friction surface. In some embodiments, the coarse surface can be textured to aid and/or improve any bonding that may be used between the stabilizers 402, 404, 406, 408 and the pontic portion 416 and/or adjacent teeth. Alternatively, one(s) of the stabilizers 402, 404, 406, 408 may have a smooth surface.

In the illustrated examples of FIGS. 4A-4B, a first stabilizer 402 is at a first end of the pontic portion 416 of the appliance 410. The first stabilizer 402 extends away from the appliance 410 in a first direction, and contacts a first tooth 412 of the adjacent teeth 412, 414. A second stabilizer 404 is at a second end of the pontic portion 416 of the appliance 410, opposite the first end. The second stabilizer 404 extends away from the appliance 410 in a second direction, opposite the first direction, and contacts a second tooth 414 of the adjacent teeth 412, 414. The first and second stabilizers 402, 404 are configured to contact the adjacent teeth 412, 414 such that the appliance 410 controls labiopalatal rotation.

In the illustrated examples of FIGS. 4A-4B, a third stabilizer 406 is at the first end of the pontic portion 416. The third stabilizer 406 extends away from the appliance 410 in the first direction and contacts the first tooth 412 of the adjacent teeth 412, 414. A fourth stabilizer 408 is at the second end of the pontic portion 416. The fourth stabilizer 408 extends away from the appliance 410 in the second direction, and contacts the second tooth 414 of the adjacent teeth 412, 414. The third and fourth stabilizers 406, 408 are configured to contact the adjacent teeth 412, 414 such that the appliance 410 controls labiopalatal rotation.

FIG. 4C illustrates a sectional view of an example appliance 430 including a pontic portion 432, a bracket portion 434, and example stabilizers 436, 438. In this example, the pontic portion 432 is coated with material 440 to protect enamel and soft tissue.

In some embodiments, the pontic portion 432 can correspond to and/or be implemented by the pontic portion 108 of FIG. 1, the pontic portion 216 of FIG. 2, the pontic portion 310 of FIGS. 3A-3B, and/or the pontic portion 416 of FIGS. 4A and 4B. In some embodiments, the bracket portion 434 can correspond to and/or be implemented by the archwire connection portion 110 of FIG. 1, the archwire connection portion 210 of FIG. 2, the archwire connection portion 311 of FIGS. 3A and 3B, and/or the archwire connection portion 420 of FIG. 4B. In some embodiments, the stabilizers 436, 438 can correspond to and/or be implemented by one(s) of the stabilizers 302, 304 of FIGS. 3A and 3B and/or one(s) of the stabilizers 402, 404, 406, 408 of FIGS. 4A and 4B. For example, a first stabilizer 436 of this example can correspond to and/or be implemented by the first stabilizer 402 of FIGS. 4A and 4B and a second stabilizer 438 of this example can correspond to and/or be implemented by the third stabilizer 406 of FIGS. 4A and 4B.

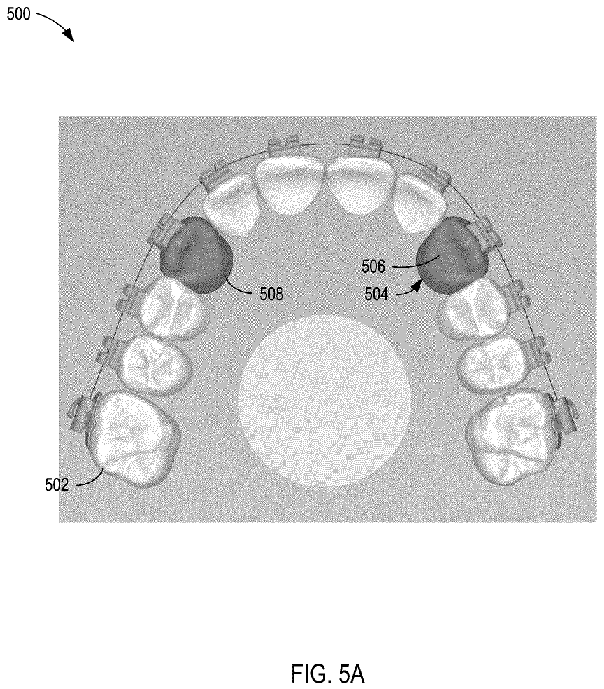

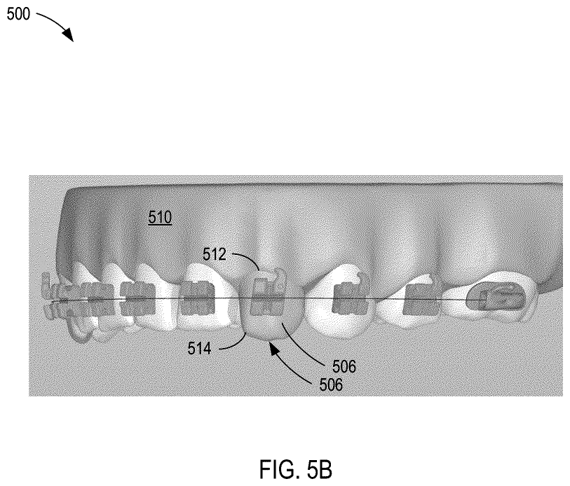

FIG. 5A is a top view of an occlusal view of an upper archform 500 associated with a treatment plan for a patient. In the illustrated example, teeth 502 are shown in their final positions. An example appliance 504 is shown filling a gap in the upper left arch between a second incisor and a first molar. The dentition of a pontic portion 506 of the appliance 504 can be based on an opposing tooth 508 in the upper right arch.

FIG. 5B is a side view of the upper archform 500 of FIG. 5A, according to some embodiments. For example, FIG. 5B shows a left side view of the upper archform of the patient associated with the upper archform 500 of FIG. 5A and includes a representation of soft tissue 510. A gingival edge 512 of the pontic portion 506 conforms to the gingival margin of the soft tissue 510 and avoids negative space. An incisal edge 514 of the pontic portion 506 is in concordance with the arch formed by adjacent teeth. Beneficially, such custom fitting pontics, such as the pontic portion 506, can be made using additive manufacturing as disclosed herein. In addition, additive manufacturing can be used to create a custom appliance that avoids the need to reshape or trim the pontic portion 506 prior to installation.

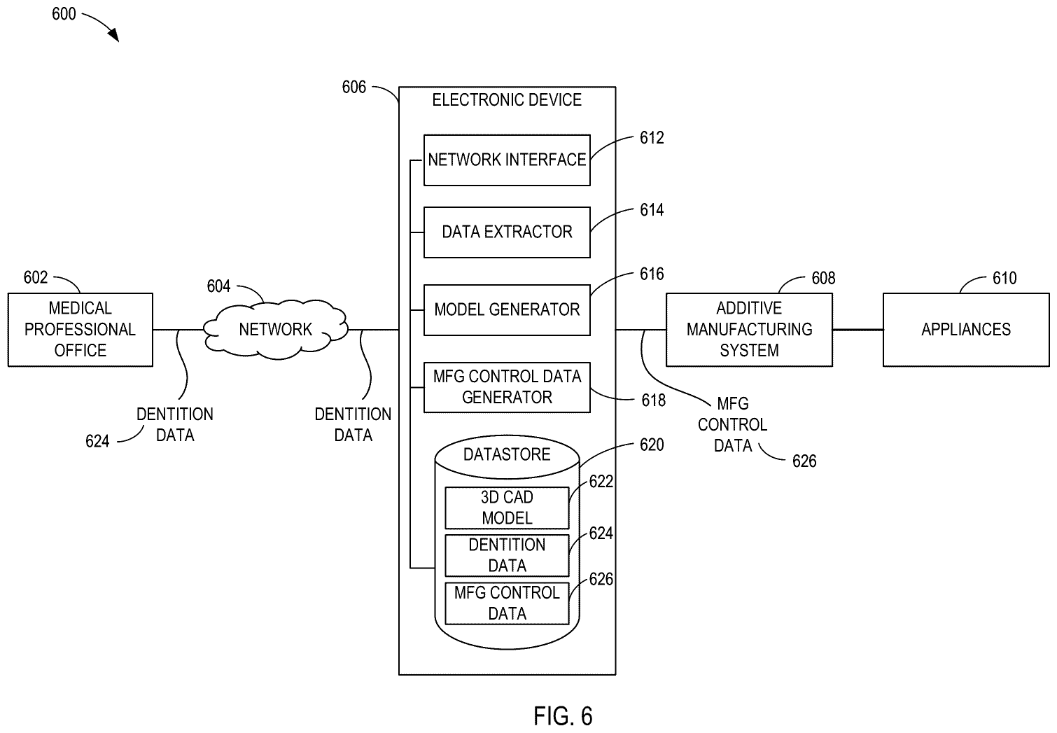

FIG. 6 shows an example appliance manufacturing system 600 including an additive manufacturing system 608 to construct example appliances 610. In some embodiments, the appliances 102, 104, 106 of FIG. 1, the appliances 202, 204, 206 of FIG. 2, the appliance 306 of FIGS. 3A-3B, the appliance 410 of FIGS. 4A-4B, the appliance 430 of FIG. 4C, and/or the appliance 504 of FIGS. 5A-5B, and/or portion(s) thereof (e.g., a pontic portion, an archwire connection portion, etc.) can implement the appliances 610 of this example. Any other types of the appliances are contemplated, such as brackets, buttons, hooks, and tubes. Further depicted in FIG. 6 are a medical professional office 602, a network 604, and an electronic device 606. The electronic device 606 of this example includes and/or implements a network interface 612, a data extractor 614, a model generator 616, a manufacturing (MFG) control data generator 618, and a datastore 620, which includes, stores, and/or implements a 3D computer-assisted design (CAD) model 622.

In some embodiments, a patient may be evaluated at the medical professional office 602 to facilitate a dental treatment plan, such as an orthodontic treatment plan. The patient may be missing one or more teeth. A medical professional, such as a dentist and/or an orthodontist, associated with the medical professional office 602, may cause the measurement of dentition data 624 to support the construction of one or more of the appliances 610 to fill the gap(s) left by the one or more missing teeth. For example, such measurement may use computerized tomography (CT) layer scanning with a non-contact 3D scanner or an intra-oral scanner directly on the patient's teeth, or may use 3D readings on a teeth model previously cast or 3D printed using a coordinate measuring machine, a laser scanner, or structured light digitizers. The scanning accuracy of such techniques is typically less than about 0.02 millimeters (mm). Non-limited examples of the dentition data 624 include CT data, 3D reading data, a 3D model of a patient's mouth, coordinate measurement machine data, laser scanner data, and structured light digitizer data.

In some embodiments, the medical professional office 602 can cause transmission of the dentition data 624 to the electronic device 606 via the network 604. The network 604 may be implemented by any wired and/or wireless network(s) such as one or more cellular networks, one or more local area networks (LANs), one or more optical fiber networks, one or more private networks, one or more public networks, one or more wireless local area networks (WLANs), etc., and/or any combination(s) thereof. For example, the network 604 may be the Internet, but any other type of private and/or public network is contemplated.

In some embodiments, the electronic device 606 can be an electronic and/or computing system that causes manufacturing of the appliances 610 based on the dentition data 624 via the additive manufacturing system 608. In some embodiments, the electronic device 606 can be associated with a designer, distributor, and/or manufacturer of the appliances 610. For example, the electronic device 606 can be a server (e.g., a computer server), a desktop computer, a laptop computer, a tablet computer, a computer workstation, etc., associated with an appliance manufacturer.

The electronic device 606 includes the network interface 612 to receive and/or obtain dentition data 624 from the network 604. For example, the network interface 612 can receive teeth measurements, a desired torque, offset, and angulation of a bracket, occlusal and/or incisal coverage for placement guide, etc., and/or any combination(s) thereof. In some embodiments, the network interface 612 can implement a Hypertext Transfer Protocol (HTTP) interface, a secure HTTP interface (HTTPS), a Simple Mail Transfer Protocol (SMTP) interface, or any other type of interface. In some embodiments, the network interface 612 can implement an Ethernet interface, a cellular network interface, and/or any other type of network protocol interface. The network interface 612 can store the dentition data 624 in the datastore 620.

The electronic device 606 includes the data extractor 614 to extract and/or identify data of interest from the dentition data 624. Additionally or alternatively to the examples of the dentition data 624 described above, non-limiting examples of information the data extractor 614 can extract includes a type of a missing tooth (e.g., an incisor, cuspid, premolar, etc., type of tooth), a location of a missing tooth, a mesiodistal width between adjacent teeth, an occlusal-gingival height of a missing tooth, and a contour of soft tissue for a gingival edge of a pontic portion. The data extractor 614 can store the extracted data in the datastore 620.

The electronic device 606 includes the model generator 616 to construct and/or generate a model, such as a 3D CAD model, of a patient's mouth and/or teeth therein based on the dentition data 624. In some embodiments, the model generator 616 can rearrange the teeth in the model to achieve the desired treatment outcomes that may be based on the long axis of a tooth. In some embodiments, one or more gaps in the teeth represented by the model may be maintained for pontic(s). In some embodiments, the model generator 616 can store the model in the datastore 620 as the 3D CAD model 622. In some embodiments, the 3D CAD model 622 can be stored (e.g., saved) in a model file format. Non-limiting examples of a model file format include Standard Triangle Language or Standard Tessellation Language format (.stl) and additive manufacturing file (.amf) format.

In some embodiments, the model generator 616 can use the dentition data 624 to create the 3D CAD model 622 to be representative of a custom orthodontic appliance for a particular patient to effectuate a desired treatment outcome for the patient. For example, bracket(s), molar tube(s), pontic(s), and/or orthodontic appliance(s) can be designed by the model generator 616, and/or, more generally, the electronic device 606, based on at least one of the 3D CAD model 622 of the measured teeth, the model of the desired treatment outcomes, or the input additional information, such as a desired torque, offset, and angulation of select brackets and occlusal/incisal coverage for placement guide. The output of the design process may be the 3D CAD model 622, which can be designed for a single lingual/labial bracket structure, including the bracket guide and bracket pad in contact with teeth surface, as well as the slots for the ideal position according to the orthodontia requirement, ceramic bracket material, tooth profile, molar tube(s), pontic(s) and/or orthodontic appliance(s). In some embodiments, a bracket guide can be a single bracket pad for a single bracket or may be a rigid ceramic rectangular archwire with two or more occlusal supports, which can be designed to assist placement of brackets via indirect bonding. In some embodiments, a bracket guide can be an indirect bonding tray. In some embodiments, 3D CAD models of a bracket structure of labial or lingual brackets, molar tube(s), pontic(s) and/or orthodontic appliance(s) can be designed by the model generator 616, and/or, more generally, the electronic device 606, to the orthodontic requirements, material, and teeth morphology.

In some embodiments, the model generator 616 can generate the 3D CAD model 622 to include one or more digital representations of a pontic, or portion(s) thereof, as disclosed herein. For example, the 3D CAD model 622 can include a model of the appliances 102, 104, 106 of FIG. 1, the appliances 202, 204, 206 of FIG. 2, the appliance 306 of FIGS. 3A-3B, the appliance 410 of FIGS. 4A-4B, the appliance 430 of FIG. 4C, and/or the appliance 504 of FIGS. 5A-5B, and/or portion(s) thereof (e.g., a pontic portion, an archwire connection portion, etc.). By way of example, the model generator 616 can digitally sculpt the pontic from a library (e.g., a digital library, a repository, etc.) of stock teeth based on the shape, size, and position of the missing tooth and adjacent teeth. In some embodiments, the pontic can be simulated in a digital treatment plan. The pontic can be a mirror image of an opposing tooth. For example, if the pontic is the second incisor on the lower right arch, the reference design for the pontic can be the second incisor on the lower left arch. In some embodiments, where the pontic is utilized in the posterior of the mouth, aesthetics is less of a concern and the pontic can be shaped entirely functionally (e.g., spherical, flat, etc.).

The electronic device 606 includes the manufacturing control data generator 618 to process the 3D CAD model 622 to generate and/or output manufacturing control data 626 (identified by MFG control data) for use by the additive manufacturing system 608. For example, the manufacturing control data 626 can be commands, configuration data, instructions, etc., and/or any combination(s) thereof that cause (e.g., control, direct, instruct) the additive manufacturing system 608 to construct the appliances 610.

The additive manufacturing system 608 can perform and/or carry out one or more 3D printing processes, and/or, more generally, additive manufacturing processes, to generate the appliances 610. Non-limiting examples of processes include ceramic slurry-based additive manufacturing technologies, such as digital light processing (DLP), laser photopolymerization stereolithography, jet printing (e.g., particle jetting, nanoparticle jetting), layer slurry depositioning (LSD), and laser-induced slip casting. For example, where the additive manufacturing system 608 implements a ceramic slurry-based additive manufacturing system, the additive manufacturing system 608 can be used to produce the appliances 610, which can include bracket(s), tube(s), pontic(s), and/or orthodontic appliance(s), by slicing the 3D CAD model 622 (e.g., a 3D CAD bracket structure model) to separate it into thin layers and get the horizontal section model for each layer. Based on this section model, the additive manufacturing system 608 can directly produce the bracket(s), tube(s), pontic(s), and/or orthodontic appliance(s), ensuring the shape of each layer is consistent to the 3D CAD structure data. For example, the thickness of such layers may be about 20 micrometers or microns (μm) to about 50 μm with a manufacturing accuracy of about 5 μm to about 10 μm by using between-layer additive error compensation. In some embodiments, the additive manufacturing system 608 can be and/or implement a polymer based additive manufacturing system, and the polymer pontic(s) and/or orthodontic appliance(s) can be formed accordingly. In some such embodiments, post processing can involve cleaning, drying, and curing.

In some embodiments, the additive manufacturing system 608 performs post-processing of the appliances 610. Non-limiting examples of post-processing operations include cleaning, a thermal treatment (for binder burnout), and a sintering process to achieve optimal or improved ceramic density. For example, a green body can be removed from a device (e.g., a build box) of the additive manufacturing system 608, exposed to a furnace to decompose the polymerized binder (a process referred to as debinding), and sintered to form a ceramic bracket, molar tube, and/or pontic. In some embodiments, the green body is an orthodontic appliance including a pontic portion and a bracket portion as disclosed herein.

The additive manufacturing system 608 can develop the appliances 610 using high strength oxides, nitrides and carbides ceramics, and/or metals. For example, the additive manufacturing system 608 can 3D print the appliances 610 using high strength oxides, nitrides and carbides ceramics, and/or metals. Non-limiting examples of such materials include Aluminum Oxide (Al2O3), Zirconium Oxide (ZrO2), Alumina-toughened Zirconia (ATZ), Zirconia-toughened alumina (ZTA), Lithium disilicate, Leucite silicate and Silicon Nitride, Stainless Steel 17-4PH or 316L, Titanium (Ti/Ti-Al6-V4), Cobalt Chromium (CoCr), Tungsten and Tungsten Carbide/Cobalt (W or WC/Co), Silicon Carbide (SiC), Molybdenum (Mo) and precious metals (e.g., gold (Au)). In some embodiments, some such materials, such as ceramics, can be coated (e.g., with a pontic paint) to achieve the benefits disclosed herein.

In some embodiments, the additive manufacturing system 608 can prepare a light-polymerizable material or photo-reactive suspension (slurry) based on commercially available di- and mono-functional methacrylates. For example, the additive manufacturing system 608 can prepare a slurry used to 3D print a ceramic appliance using di- and mono-functional methacrylates. A non-limiting example of a light-polymerizable material or photo-reactive suspension is a slurry blend of about 0.01-0.025 wt % of a highly reactive photoinitiator, about 0.05-6 wt % of a dispersant, an absorber, and about 2-20 wt % of a non-reactive diluent. For example, photoinitiators, methacrylates, and dispersants can be burned up and/or disintegrated during 3D printing and/or a subsequent curing process to leave the ceramic appliance behind and intact. In some embodiments, a solid loading of a high strength oxide ceramic such as Aluminum Oxide (Al2O3) and Zirconium Oxide (ZrO2) powder can be used, but other ceramic materials and metals can be used.

In some embodiments, the loading of alumina or zirconia in the slurry (e.g., the ceramic slurry) can be greater than or about 49 wt %, 50 wt %, 55 wt %, 60 wt %, 65 wt %, 70 wt %, 75 wt %, 80 wt %, 85 wt %, 90 wt %, 95 wt %, or 99 wt %. In some embodiments, the loading of alumina or zirconia in the slurry can be between 50-60 wt %, 60-70 wt %, 70-80 wt %, 80-90 wt %, 90-95 wt %, 95-100 wt %. In some embodiments, the purity of the sintered alumina or zirconia can be greater than or about 95 wt %, 95.5 wt %. 96 wt %. 96.5 wt %, 97 wt %, 97.5 wt %, 98 wt %, 98.5 wt %, 99 wt %, 99.1 wt %, 99.2 wt %, 99.3 wt %, 99.4 wt %, 99.5 wt %, 99.6 wt %, 99.7 wt %, 99.8 wt % or 99.9 wt %. In some embodiments, the reduction in part size from green body to sintered part can be about 5%, 10%, 15%, 20%, 25%, 30%, 35%, 40%, 45% or 50%.

The acrylate moiety can be a monomer, oligomer or polymer. The acrylate moiety can include more than one methacrylate moiety. The weight content of the acrylate moiety can be between 5 wt % and 50 wt %. In some embodiments, the weight content is greater than or about 5, 10, 15, 20, 25, 30, 35, 40, or 45 wt %. The acrylate moiety can be a methacrylate moiety or an acrylate ester.

In some embodiments, the pontic portion of the appliances 610, ceramic or polymer, can next be at least partially coated with a material that is softer than tooth enamel (e.g., a pontic paint). In some embodiments, stabilizers can be applied at this stage. Curing of the coating can be carried out. In some embodiments, the stabilizers can be formed through additive manufacturing via the additive manufacturing system 608 while the pontic is being formed. For example, the model generator 616 can generate the 3D CAD model 622 to include a model of the appliance 306, which includes the pontic portion 310, the archwire connection portion 311, and the stabilizers 302, 304. The manufacturing control data generator 618 can generate, based on the 3D CAD model 622, the manufacturing control data 626 to instruct the additive manufacturing system 608 to construct at least one of the pontic portion 310, the archwire connection portion 311, or the stabilizers 302, 304 as a single body. Alternatively, the manufacturing control data 626 may cause the additive manufacturing system 608 to construct the pontic portion 310, the archwire connection portion 311, and/or the stabilizers 302, 304 as separate bodies.

The electronic device 606 includes the datastore 620 to record data. Non-limiting examples of recorded data include the dentition data 624, the 3D CAD model 622, and the manufacturing control data 626. In some embodiments, the datastore 620 may be implemented by any technology for storing data. For example, the datastore 620 may be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The datastore 620 may additionally or alternatively be implemented by one or more double data rate (DDR) memories, such as DDR, DDR2, DDR3, DDR4, mobile DDR (mDDR), etc. The datastore 620 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the datastore 620 is illustrated as a single datastore, the datastore 620 may be implemented by any number and/or type(s) of datastores. Furthermore, the data stored in the datastore 620 may be in any data format. Non-limiting examples of data formats include a CAD model (e.g., a 3D CAD model), a flat file, binary data, comma delimited data, tab delimited data, and structured query language (SQL) structures.

While an example implementation of the electronic device 606, and/or, more generally, the appliance manufacturing system 600, is depicted in FIG. 6, other implementations are contemplated. For example, one or more blocks, components, functions, etc., of the electronic device 606 and/or the appliance manufacturing system 600 may be combined or divided in any other way. The electronic device 606 of the illustrated example may be implemented by hardware alone, or by a combination of hardware, software, and/or firmware. For example, the electronic device 606 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), etc.), one or more network interfaces (e.g., network interface circuitry, network interface cards (NICs), smart NICs, etc.), one or more ASICs, one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

FIG. 7 is a flowchart 700 representative of machine-readable instructions that may be executed by processor circuitry to implement an electronic device, such as the electronic device 606 of FIG. 6, and/or, more generally, an appliance manufacturing system, such as the appliance manufacturing system 600 of FIG. 6. Additionally or alternatively, one or more blocks of the flowchart 700 of FIG. 7 may be representative of state(s) of one or more hardware-implemented state machines, algorithm(s) that may be implemented by hardware alone such as an ASIC, etc., and/or any combination(s) thereof.

Turning to the illustrated example of FIG. 7, the flowchart 700 may be executed and/or performed to construct appliance(s) as disclosed herein, which may include orthodontic brackets, molar tubes, pontics, and/or orthodontic appliances. The flowchart 700 FIG. 7 begins at block 702, at which the appliance manufacturing system 600 may measure dentition data associated with a patient. For example, a medical professional associated with the medical professional office 602 of FIG. 6 may measure and/or generate the dentition data 624. In some embodiments, the medical professional may generate the dentition data 624 via CT layer scanning, 3D readings on a teeth model previously cast or 3D printed using a coordinate measuring machine, a laser scanner, or structured light digitizers. In some embodiments, the dentition data 624 may be transmitted to the electronic device 606 via the network 604.

At block 704, the appliance manufacturing system 600 generates a 3D CAD model of teeth maintaining gap(s) for pontic(s). For example, after the network interface 612 receives the dentition data 624 via the network 604, the data extractor 614 can extract and/or identify data of interest for use in creating the 3D CAD model 622. In some embodiments, the model generator 616 can generate the 3D CAD model 622 based on the extracted data from the dentition data 624. In some embodiments, the 3D CAD model 622 can be a digital representation of the upper archform 500 of FIGS. 5A-5B and may leave a gap for later insertion of the appliance 504 of FIGS. 5A-5B.

At block 706, the appliance manufacturing system 600 rearranges teeth to achieve desired treatment outcome based on the dentition data. For example, the model generator 616 can rearrange and/or otherwise move one(s) of the teeth in the upper archform 500 to achieve the desired treatment outcomes that may be based on the long axis of a tooth.

At block 708, the appliance manufacturing system 600 obtains configuration data. For example, the model generator 616 can obtain, such as from the dentition data 624 and/or from a user of the electronic device 606 via a user interface associated with the electronic device 606, configuration data. Non-limiting examples of configuration data include a desired and/or specified torque, offset, and angulation of select brackets and occlusal/incisal coverage for placement guide. Additional non-limiting examples of configuration data include information regarding a type of missing tooth (e.g., incisor, cuspid, premolar, etc.), a location of a missing tooth, a mesiodistal width between adjacent teeth, an occlusal-gingival height of a missing tooth, and contour of soft tissue for gingival edge of a pontic portion of an appliance.

At block 710, the appliance manufacturing system 600 constructs appliance(s) based on at least one of the 3D CAD model or the configuration data. For example, the manufacturing control data generator 618 can generate and/or output the manufacturing control data 626 to the additive manufacturing system 608. In some embodiments, the manufacturing control data 626 can cause the additive manufacturing system 608 to produce one or more of the appliances 610 using additive manufacturing techniques as disclosed herein. For example, the additive manufacturing system 608 can separate the 3D CAD model 622, based on the manufacturing control data 626, into thin layers and obtain the horizontal section model for each layer. Based on this section model, the additive manufacturing system 608 can produce ones of the appliances 610, which can include bracket(s), tube(s), pontic(s), and/or orthodontic appliance(s), ensuring the shape of each layer is consistent to the structured data of the 3D CAD model 622.

At block 712, the appliance manufacturing system 600 performs post-processing of the appliance(s). For example, the additive manufacturing system 608 can carry out cleaning, a thermal treatment (for binder burnout), and/or a sintering process to achieve optimal and/or otherwise improved ceramic density (in the example of the additive manufacturing system 608 implementing a ceramic slurry-based additive manufacturing system). Alternatively, post processing may include cleaning, drying, and curing in the example of the additive manufacturing system 608 implementing a polymer-based additive manufacturing system.

At block 714, the appliance manufacturing system 600 determines whether to construct appliance(s) for another patient. For example, the electronic device 606 can determine that additional appliance(s) is/are to be constructed based on dentition data being received by the network interface 612 for a different patient. If, at block 714, the electronic device 606 determines to construct appliance(s) for another patient, control returns to block 702. Otherwise, the example flowchart 700 of the illustrated example of FIG. 7 concludes.

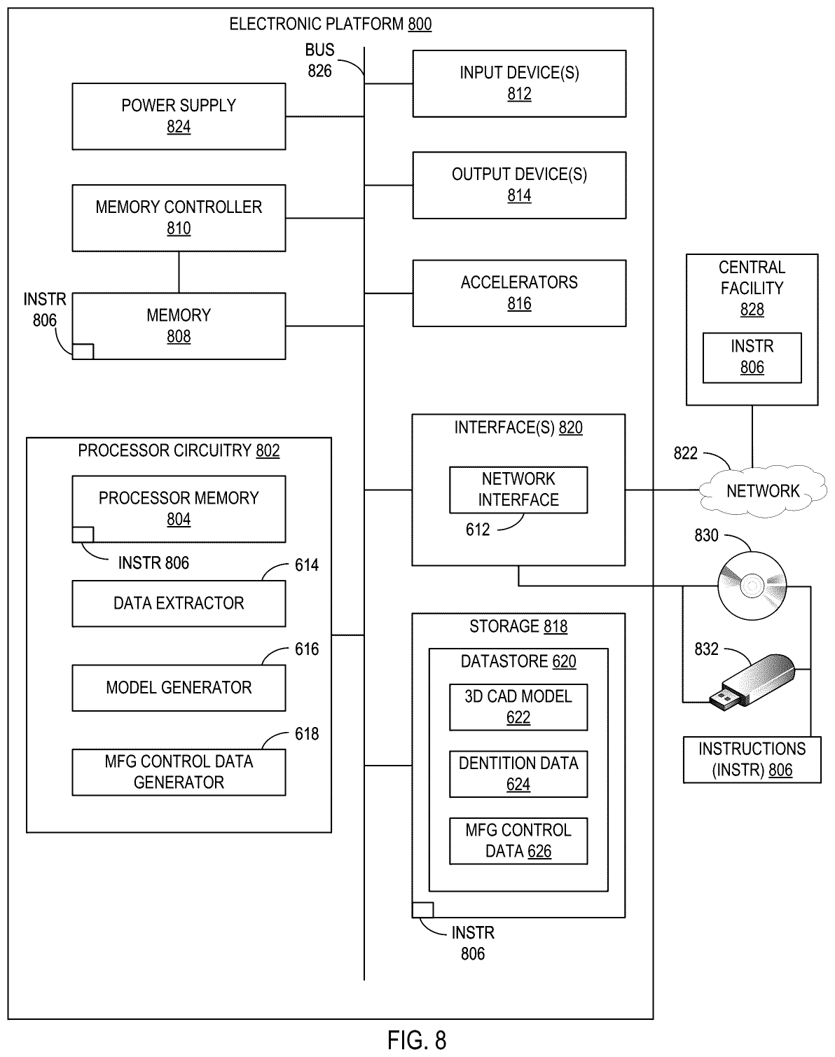

FIG. 8 is an example implementation of an electronic platform 800 structured to execute the machine-readable instructions of FIG. 7 to implement an electronic device, such as the electronic device 606 of FIG. 6. It should be appreciated that FIG. 8 is intended neither to be a description of necessary components for an electronic and/or computing device to operate as the electronic device 606, in accordance with the techniques described herein, nor a comprehensive depiction. The electronic platform 800 of this example may be an electronic device, such as a desktop computer, a laptop computer, a server (e.g., a computer server, a blade server, a rack-mounted server, etc.), a tablet computer, a computer workstation, or any other type of computing and/or electronic device.

The electronic platform 800 of the illustrated example includes processor circuitry 802, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, etc., and/or any combination(s) thereof. The processor circuitry 802 includes processor memory 804, which may be volatile memory, such as random-access memory (RAM) of any type. The processor circuitry 802 of this example implements the data extractor 614, the model generator 616, and the manufacturing control data generator 618 of FIG. 6.

The processor circuitry 802 may execute machine-readable instructions 806 (identified by INSTRUCTIONS), which are stored in the processor memory 804, to implement at least one of the data extractor 614, the model generator 616, or the manufacturing control data generator 618 of FIG. 6. The machine-readable instructions 806 may include data representative of computer-executable and/or machine-executable instructions implementing techniques that operate according to the techniques described herein. For example, the machine-readable instructions 806 may include data (e.g., code, embedded software (e.g., firmware), software, etc.) representative of the flowchart 700 of FIG. 7, or portion(s) thereof.

The electronic platform 800 includes memory 808, which may include the machine-readable instructions 806. The memory 808 of this example may be controlled by a memory controller 810. For example, the memory controller 810 may control reads, writes, and/or, more generally, access(es) to the memory 808 by other component(s) of the electronic platform 800. The memory 808 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 800 includes input device(s) 812 to enable data and/or commands to be entered into the processor circuitry 802. For example, the input device(s) 812 may include an audio sensor, a camera (e.g., a still camera, a video camera, etc.), a keyboard, a microphone, a mouse, a touchscreen, a voice recognition system, etc., and/or any combination(s) thereof.

The electronic platform 800 includes output device(s) 814 to convey, display, and/or present information to a user (e.g., a human user, a machine user, etc.). For example, the output device(s) 814 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 814 can be used, among other things, to generate, launch, and/or present a user interface. For example, the user interface may be generated and/or implemented by the output device(s) 814 for visual presentation of output and speakers or other sound generating devices for audible presentation of output.

The electronic platform 800 includes accelerators 816, which are hardware devices to which the processor circuitry 802 may offload compute tasks to accelerate their processing. For example, the accelerators 816 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the data extractor 614, the model generator 616, and/or the manufacturing control data generator 618 may be implemented by one(s) of the accelerators 816 instead of the processor circuitry 802. In some examples, the data extractor 614, the model generator 616, and/or the manufacturing control data generator 618 may be executed concurrently (e.g., in parallel, substantially in parallel, etc.) by the processor circuitry 802 and the accelerators 816. For example, the processor circuitry 802 and one(s) of the accelerators 816 may execute in parallel function(s) corresponding to the model generator 616.

The electronic platform 800 includes storage 818 to record and/or control access to data, such as the machine-readable instructions 806. In this example, the storage 818 may implement the datastore 620, the 3D CAD model 622, the dentition data 624, and the manufacturing control data 626. The storage 818 may be implemented by one or more mass storage disks or devices, such as HDDs, SSDs, etc., and/or any combination(s) thereof.

The electronic platform 800 includes interface(s) 820 to effectuate exchange of data with external devices (e.g., computing and/or electronic devices of any kind) via a network 822. In some embodiments, the network 822 can be implemented by the network 604 of FIG. 6. In this example, the interface(s) 820 may implement the network interface 612 of FIG. 6. In some embodiments, the interface(s) 820 may be used to communicate with an additive manufacturing system, such as the additive manufacturing system 608 of FIG. 6. For example, the interface(s) 820 may implement one or more interfaces to transmit data to and/or receive data from the additive manufacturing system 608.

The interface(s) 820 of the illustrated example may be implemented by an interface device, such as network interface circuitry (e.g., a NIC, a smart NIC, etc.), a gateway, a router, a switch, etc., and/or any combination(s) thereof. The interface(s) 820 may implement any type of communication interface, such as BLUETOOTH®, a cellular telephone system (e.g., a 4G LTE interface, a 5G interface, a 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 800 includes a power supply 824 to store energy and provide power to components of the electronic platform 800. The power supply 824 may be implemented by a power converter, such as an alternating current-to-direct-current (AC/DC) power converter, a direct current-to-direct current (DC/DC) power converter, etc., and/or any combination(s) thereof. For example, the power supply 824 may be powered by an external power source, such as an alternating current (AC) power source (e.g., an electrical grid), a direct current (DC) power source (e.g., a battery, a battery backup system, etc.), etc., and the power supply 824 may convert the AC input or the DC input into a suitable voltage for use by the electronic platform 800. In some examples, the power supply 824 may be a limited duration power source, such as a battery (e.g., a rechargeable battery such as a lithium-ion battery).

Component(s) of the electronic platform 800 may be in communication with one(s) of each other via a bus 826. For example, the bus 826 may be any type of computing and/or electrical bus, such as an I2C bus, a PCI bus, a PCIe bus, a SPI bus, and/or the like.

The network 822 may be implemented by any wired and/or wireless network(s) such as one or more cellular networks (e.g., 4G LTE cellular networks, 5G cellular networks, 6G cellular networks, etc.), one or more data buses, one or more LANs, one or more optical fiber networks, one or more private networks, one or more public networks, one or more WLANs, etc., and/or any combination(s) thereof. For example, the network 822 may be the Internet, but any other type of private and/or public network is contemplated.

The network 822 of the illustrated example facilitates communication between the interface(s) 820 and a central facility 828. The central facility 828 in this example may be an entity associated with one or more servers, such as one or more physical hardware servers and/or virtualizations of the one or more physical hardware servers. For example, the central facility 828 may be implemented by a public cloud provider, a private cloud provider, etc., and/or any combination(s) thereof. In this example, the central facility 828 may compile, generate, update, etc., the machine-readable instructions 806 and store the machine-readable instructions 806 for access (e.g., download) via the network 822. For example, the electronic platform 800 may transmit a request, via the interface(s) 820, to the central facility 828 for the machine-readable instructions 806 and receive the machine-readable instructions 806 from the central facility 828 via the network 822 in response to the request.

Additionally or alternatively, the interface(s) 820 may receive the machine-readable instructions 806 via non-transitory machine-readable storage media, such as an optical disc 830 (e.g., a Blu-ray disc, a CD, a DVD, etc.) or any other type of removable non-transitory machine-readable storage media such as a USB drive 832. For example, the optical disc 830 and/or the USB drive 832 may store the machine-readable instructions 806 thereon and provide the machine-readable instructions 806 to the electronic platform 800 via the interface(s) 820.

Techniques operating according to the principles described herein may be implemented in any suitable manner. The processing and decision blocks of the flowchart above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowchart included herein do not depict the syntax or operation of any particular circuit or of any particular programming language or type of programming language. Rather, the flowchart illustrates the functional information one skilled in the art may use to fabricate circuits or to implement computer software algorithms to perform the processing of a particular apparatus carrying out the types of techniques described herein. For example, the flowchart, or portion(s) thereof, may be implemented by hardware alone (e.g., one or more analog or digital circuits, one or more hardware-implemented state machines, etc., and/or any combination(s) thereof) that is configured or structured to carry out the various processes of the flowchart. In some examples, the flowchart, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowchart. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions implementing the techniques described herein (when implemented as one or more functional facilities or in any other manner) may, in some embodiments, be encoded on one or more computer-readable media, machine-readable media, etc., to provide functionality to the media. Computer-readable media include magnetic media such as a hard disk drive, optical media such as a CD or a DVD, a persistent or non-persistent solid-state memory (e.g., flash memory, magnetic RAM, etc.), or any other suitable storage media. Such a computer-readable medium may be implemented in any suitable manner. As used herein, the terms “computer-readable media” (also called “computer-readable storage media”) and “machine-readable media” (also called “machine-readable storage media”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:

1. An appliance for spanning a mesiodistal width of a missing tooth, comprising: a pontic portion at least partially coated with a material that is softer than tooth enamel; an archwire connection portion attached to a first side of the pontic portion; and at least one stabilizer affixed to a second side of the pontic portion, the second side opposite the first side.

2. The appliance of aspect 1, wherein the archwire connection portion is a bracket.

3. The appliance of aspect 2, wherein the bracket is a self-ligating bracket.

4. The appliance of aspect 1, wherein the archwire connection portion is a tube.

5. The appliance of any of aspects 1-4, wherein the at least one stabilizer is affixed to the second side to control labiopalatal rotation of the pontic portion around an archwire to be coupled to the archwire connection portion.

6. The appliance of any of aspects 1-5, wherein the at least one stabilizer is at least partially embedded in the pontic portion.

7. The appliance of any of aspects 1-6, wherein the at least one stabilizer is dovetail shaped.

8. The appliance of any of aspects 1-7, wherein a slot of the archwire connection portion comprises a coarse surface shaped to inhibit rotation of the pontic portion around an archwire to be coupled to the archwire connection portion.

9. The appliance of any of aspects 1-8, wherein the archwire connection portion is comprised of a ceramic or a polymer.

10. The appliance of any of aspects 1-9, wherein the pontic portion is comprised of ceramic or a polymer.

11. The appliance of any of aspects 1-10, wherein the material comprises a coating comprising an acrylate.

12. The appliance of any of aspects 1-11, wherein at least one of the pontic portion or the archwire connection portion are manufactured as a single body using an additive manufacturing process.

13. The appliance of any of aspects 1-12, wherein a gingival edge of the pontic portion is configured to conform to a gingival margin of soft tissue.

14. The appliance of any of aspects 1-13, wherein the at least one stabilizer is formed through an additive manufacturing process.

15. The appliance of any of aspects 1-14, wherein the appliance is configured to maintain the mesiodistal width of the missing tooth.

16. A method for manufacturing an appliance for spanning a mesiodistal width of a missing tooth, comprising: measuring dentition data associated with a patient; generating a computer model of teeth of the patient, the computer model to maintain at least one gap for at least one pontic; and constructing, using an additive manufacturing process, the appliance based on at least one of the dentition data or the computer model, the appliance comprising: a pontic portion at least partially coated with a material that is softer than tooth enamel; an archwire connection portion attached to a first side of the pontic portion; and at least one stabilizer affixed to a second side of the pontic portion, the second side opposite the first side.

17. The method of aspect 16, further comprising rearranging the teeth in the computer model to facilitate a dental treatment plan.

18. The method of any of aspects 16-17, further comprising performing post-processing on the appliance comprising at least one of cleaning, thermal treatment, or sintering.

19. An apparatus comprising a memory storing instructions, and a processor configured to execute the instructions to perform the method of any of aspects 16-18.

20. At least one non-transitory computer-readable storage medium comprising instructions that, when executed, cause a processor to perform the method of any of aspects 16-18.

What is claimed is:

1. An appliance for spanning a mesiodistal width of a missing tooth, comprising:
a pontic portion at least partially coated with a material that is softer than tooth enamel;
an archwire connection portion attached to a first side of the pontic portion; and
at least one stabilizer affixed to a second side of the pontic portion, the second side opposite the first side.

2. The appliance of claim 1, wherein the archwire connection portion is a bracket.

3. The appliance of claim 2, wherein the bracket is a self-ligating bracket.

4. The appliance of claim 1, wherein the archwire connection portion is a tube.

5. The appliance of claim 1, wherein the at least one stabilizer is affixed to the second side to control labiopalatal rotation of the pontic portion around an archwire to be coupled to the archwire connection portion.

6. The appliance of claim 1, wherein the at least one stabilizer is at least partially embedded in the pontic portion.

7. The appliance of claim 1, wherein the at least one stabilizer is dovetail shaped.

8. The appliance of claim 1, wherein a slot of the archwire connection portion comprises a coarse surface shaped to inhibit rotation of the pontic portion around an archwire to be coupled to the archwire connection portion.

9. The appliance of claim 1, wherein the archwire connection portion is comprised of a ceramic or a polymer.

10. The appliance of claim 1, wherein the pontic portion is comprised of ceramic or a polymer.

11. The appliance of claim 1, wherein the material comprises a coating comprising an acrylate.

12. The appliance of claim 1, wherein at least one of the pontic portion or the archwire connection portion are manufactured as a single body using an additive manufacturing process.

13. The appliance of claim 1, wherein a gingival edge of the pontic portion is configured to conform to a gingival margin of soft tissue.

14. The appliance of claim 1, wherein the at least one stabilizer is formed through an additive manufacturing process.

15. The appliance of claim 1, wherein the appliance is configured to maintain the mesiodistal width of the missing tooth.

16. A method for manufacturing an appliance for spanning a mesiodistal width of a missing tooth, comprising:
measuring dentition data associated with a patient;
generating a computer model of teeth of the patient, the computer model to maintain at least one gap for at least one pontic; and
constructing, using an additive manufacturing process, the appliance based on at least one of the dentition data or the computer model, the appliance comprising:
a pontic portion at least partially coated with a material that is softer than tooth enamel;
an archwire connection portion attached to a first side of the pontic portion; and
at least one stabilizer affixed to a second side of the pontic portion, the second side opposite the first side.

17. The method of claim 16, further comprising rearranging the teeth in the computer model to facilitate a dental treatment plan.

18. The method of claim 16, further comprising performing post-processing on the appliance comprising at least one of cleaning, thermal treatment, or sintering.

19. An apparatus comprising:
a memory to store instructions; and
a processor configured to execute the instructions to:
obtain dentition data associated with a patient;
generate a computer model of teeth of the patient, the computer model to maintain at least one gap for at least one pontic; and
cause construction, using an additive manufacturing process, of the appliance based on at least one of the dentition data or the computer model, the appliance comprising:
a pontic portion at least partially coated with a material that is softer than tooth enamel;
an archwire connection portion attached to a first side of the pontic portion; and
at least one stabilizer affixed to a second side of the pontic portion, the second side opposite the first side.

20. At least one non-transitory computer-readable storage medium comprising instructions that, when executed, cause a processor to:
obtain dentition data associated with a patient;
generate a computer model of teeth of the patient, the computer model to maintain at least one gap for at least one pontic; and
cause construction, using an additive manufacturing process, of the appliance based on at least one of the dentition data or the computer model, the appliance comprising:
a pontic portion at least partially coated with a material that is softer than tooth enamel;
an archwire connection portion attached to a first side of the pontic portion; and
at least one stabilizer affixed to a second side of the pontic portion, the second side opposite the first side.
